(19) United States
(12) Patent Application Publication
(10) Pub. No.: US 2021/0079824 A1
(43) Pub. Date: Mar. 18, 2021

(54) REDUCTANT INSERTION ASSEMBLY PUMPS INCLUDING A CORROSION RESISTANT LAYER

(71) Applicant: Cummins Emission Solutions Inc., Columbus, IN (US)

(72) Inventors: Sandeep Shetty, Columbus, IN (US); Anusha Chilukuri, Bargersville, IN (US); Souleymane Zampaligre, Indianapolis, IN (US); Jeffrey J. Sullivan, Columbus, IN (US)

(73) Assignee: Cummins Emission Solutions Inc., Columbus, IN (US)

(21) Appl. No.: 16/573,528

(22) Filed: Sep. 17, 2019

(51) Int. Cl. F01N 3/20; F01N 3/08

(52) U.S. Cl. CPC F01N 3/208; F01N 3/0807; F01N 2510/08; F01N 2610/146; F01N 2610/1433

(57) ABSTRACT

A pump for a reductant insertion assembly, comprises a housing configured to receive a reductant. A pumping element is disposed within the housing. The pumping element configured to pressurize the reductant and communicate the pressurized reductant out of the housing. The housing and/or the pumping element comprises aluminum, and the pump further comprises a corrosion resistant layer disposed on at least a portion of a surface of the housing and/or the pumping element that is configured to contact the reductant. The corrosion resistant layer comprising a fluoropolymer.

### TECHNICAL FIELD

The present disclosure relates generally to reductant insertion assembly pumps for use in aftertreatment systems.

### BACKGROUND

Exhaust aftertreatment systems are used to receive and treat exhaust gas generated by internal combustion engines. Generally, exhaust gas aftertreatment systems include any of several different components to reduce the levels of harmful exhaust emissions present in the exhaust gas. For example, certain exhaust gas aftertreatment systems for diesel-powered internal combustion engines include a selective catalytic reduction (SCR) system including a catalyst formulated to convert NOx (NO and NO₂ in some fraction) into harmless nitrogen gas (N₂) and water vapor (H₂O) in the presence of ammonia (NH₃). Generally, in such aftertreatment systems, a reductant (e.g., a diesel exhaust fluid such as urea) is injected into the SCR system to provide a source of ammonia, and mixed with the exhaust gas to partially reduce the NOx gases. The reduction byproducts of the exhaust gas are then fluidly communicated to the catalyst included in the SCR system to decompose substantially all of the NOx gases into relatively harmless byproducts which are expelled out of the aftertreatment system. The reductant is generally pumped via a pump of a reductant insertion assembly. In some instances, the reductant may have a high content of hydrochloride or other halogen ions that can corrode surfaces of the pump, and eventually lead to failure of the pump.

### SUMMARY

Embodiments described herein relate generally to systems and methods for protecting pumps included in reductant insertion assemblies from corrosion by a reductant, and in particular, to pumps that include a corrosion resistant layer disposed on at least a portion of surfaces of the pump that come in contact with reductant.

In some embodiments, a pump for a reductant insertion assembly comprises: a housing configured to receive a reductant; and a pumping element disposed within the housing, the pumping element configured to pressurize the reductant and communicate the pressurized reductant out of the housing, wherein the housing and/or the pumping element comprises aluminum, and wherein the pump further comprises a corrosion resistant layer disposed on at least a portion of a surface of the housing and/or the pumping element that is configured to contact the reductant, the corrosion resistant layer comprising a fluoropolymer.

In some embodiments, a method of using a reductant insertion assembly fluidly coupled to an aftertreatment system that is configured to treat constituents of an exhaust gas flowing therethrough, comprises: activating a pump of the reductant insertion assembly to pressurize a reductant and communicate the pressurized reductant to a reductant injector coupled to the aftertreatment system. The pump comprises: a housing configured to receive a reductant, and a pumping element disposed within the housing, the pumping element configured to pressurize the reductant and communicate the pressurized reductant out of the housing, wherein the housing and/or the pumping element comprises aluminum, and wherein the pump further comprises a corrosion resistant layer disposed on at least a portion of a surface of the housing and/or the pumping element that is configured to contact the reductant, the corrosion resistant layer comprising a fluoropolymer; and activating the reductant injector to insert the reductant into the exhaust gas flowing through the aftertreatment system. The reductant comprises halogen ions.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 is a schematic illustration of an aftertreatment system, according to an embodiment.

FIG. 2 is a schematic illustration of a pump for a reductant insertion assembly, according to another embodiment.

FIG. 3 is a side cross-section view of a pump for a reductant insertion assembly, according to another embodiment.

FIG. 4 is a schematic flow diagram of a method for protecting a pump for a reductant insertion assembly from corrosion by a reductant, according to an embodiment.

FIG. 5 is a schematic flow diagram of another method for operating a reductant insertion assembly, according to an embodiment.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Embodiments described herein relate generally to systems and methods for protecting pumps included in reductant insertion assemblies from corrosion by a reductant, and in particular, to pumps that include a corrosion resistant layer disposed on at least a portion of surfaces of the pump that come in contact with reductant.

Pumps for use with reductant insertion assemblies are generally made from aluminum. The aluminum surfaces of such pumps have a natural aluminum oxide layer disposed thereon. The native aluminum oxide layer serves as a protective layer that has natural resistance to oxidation by pH neutral aqueous solutions. Generally, the reductants for use with such pumps, for example, ISO 22241 diesel exhaust fluid, are formulated to have a low halogen content. The natural aluminum oxide layer on the inner surfaces of the pump that contact such reductant is sufficient to protect the inner surfaces of the pump from corrosion from such ISO standard reductants.

In some instances however, the reductant may have a high halogen content (e.g., a high content of chloride, bromide, fluoride or iodide ions). For example, in some instances, inferior quality reductant that does not conform to the ISO 22241 standard may be used. Such reductants may have a high concentration of halogen ions. In such instances, the chloride ions may react with the aluminum oxide film and corrode the film. The reaction rate may be particularly high at high operating temperature of the pump. The halogen ions thin the aluminum oxide layer and convert the layer into an unstable hydroxide layer that is susceptible to pitting, cracking and descaling from the base aluminum layer. The halogen ions in the reductant can then corrode the underlying aluminum layer. In some embodiments, corrosion may also be caused by other substances, such as road salts (e.g., salts used to melt ice) that may accumulate on the housing of the pump. The aluminum dioxide film can also degrade depending on temperature of the reductant, dwell time of the reductant in the pump, and/or thermal shock. Cracked portions of the aluminum oxide films and aluminum particles released from the surfaces of the pump due to corrosion by high halogen content reductants can damage a pumping element (e.g., an impeller) of the pump and also clog upstream and/or downstream filters leading to pressure drop. This may lead to loss of pumping pressure and eventual failure of the pump.

Various embodiments of the pumps for reductant insertion assemblies described herein may provide one or more benefits including, for example: (1) providing a corrosion resistant layer disposed on surfaces of the pump that contact a reductant having a high halogen content, thereby inhibiting corrosion; (2) increasing service life of the pump and downstream components; and (3) and reducing maintenance costs.

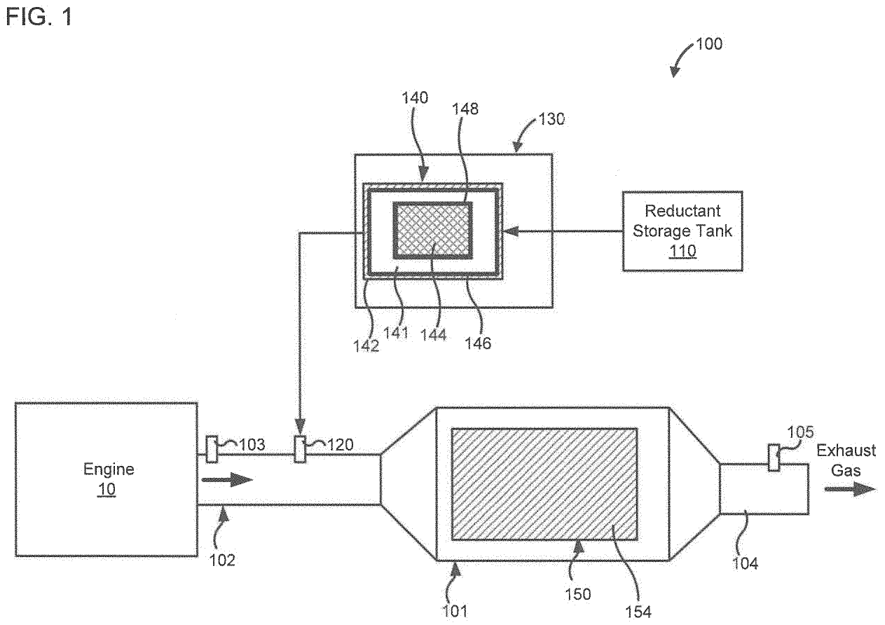

FIG. 1 is a schematic illustration of an aftertreatment system 100, according to an embodiment. The aftertreatment system 100 is configured to receive an exhaust gas (e.g., a diesel exhaust gas) from an engine 10 and decompose constituents of the exhaust gas such as, for example, NOx gases, CO, etc. The aftertreatment system 100 includes a reductant storage tank 110, a reductant insertion assembly 130, and a SCR system 150.

The engine 10 may include an internal combustion engine, for example a diesel engine, a gasoline engine, a natural gas engine, a biodiesel engine, a dual fuel engine, an alcohol engine, an E85 or any other suitable internal combustion engine. The engine 10 generates an exhaust gas that is communicated to the aftertreatment system 100.

The reductant storage tank 110 contains a reductant formulated to facilitate reduction of the constituents of the exhaust gas (e.g., NOx gases) by a catalyst 154 included in the SCR system 150. In embodiments in which the exhaust gas is a diesel exhaust gas, the reductant may include a diesel exhaust fluid (DEF) which provides a source of ammonia. Suitable DEFs can include urea, aqueous solution of urea or any other DEF (e.g., the DEF available under the tradename ADBLUE®). In particular embodiments, the reductant includes an aqueous urea solution containing 32.5 wt % urea and 67.5 wt % de-ionized water. In other embodiments, the reductant includes aqueous urea solution containing 40 wt % urea and 60 wt % de-ionized water. In some embodiments, the reductant may include a high halogen content, for example, an amount of halogen ions (e.g., chloride or bromide ions), for example, greater than about 10 parts per million (ppm) or about 10 mg/liter.

The SCR system 150 is configured to receive and treat the exhaust gas (e.g., a diesel exhaust gas) flowing through the SCR system 150 in the presence of ammonia. The aftertreatment system 100 includes an exhaust conduit 101 defining an exhaust flow path configured to receive the exhaust gas from the engine 10. The SCR system 150 is positioned within the exhaust conduit 101. In some embodiments, the exhaust conduit 101 includes an inlet tube 102 positioned upstream of the SCR system 150 and configured to receive exhaust gas from the engine 10 and communicate the exhaust gas to the SCR system 150. The exhaust conduit 101 may also include an outlet tube 104 for expelling treated exhaust gas into the environment.

A first sensor 103 may be positioned in the inlet tube 102. The first sensor 103 may include, for example a NOx sensor (e.g., a physical or virtual NOx sensor), an oxygen sensor, a particulate matter sensor, a carbon monoxide sensor, a temperature sensor, a pressure sensor, any other sensor or a combination thereof configured to measure one or more operational parameters of the exhaust gas. Such operating parameters may include, for example, an amount of NOx gases in the exhaust gas, a temperature of the exhaust gas, a flow rate and/or pressure of the exhaust gas.

A second sensor 105 may be positioned in the outlet tube 104. The second sensor 105 may include a second NOx sensor configured to determine an amount of NOx gases expelled into the environment after passing through the SCR system 150. In other embodiments, the second sensor 105 may comprise a particulate matter sensor configured to determine an amount of particulate matter (e.g., soot or ash) included in the exhaust gas. In still other embodiments, the second sensor 105 may include an ammonia sensor configured to measure an amount of ammonia in the exhaust gas flowing out of the SCR system 150, i.e., determine the ammonia slip. The ammonia slip may be used as a measure of catalytic conversion efficiency of the SCR system 150, for adjusting an amount of reductant to be inserted into the SCR system 150, and/or for adjusting a temperature of the SCR system 150 so as to allow the SCR system 150 to effectively use the ammonia for catalytic decomposition of the NOx gases included in the exhaust gas flowing therethrough. In some embodiments, an ammonia oxide (AMOx) catalyst may be positioned downstream of the SCR system 150, for example, in the outlet tube 104 so as to decompose any unreacted ammonia in the exhaust gas downstream of the SCR system 150.

The SCR system 150 includes at least one catalyst 154 positioned within an internal volume defined by the exhaust conduit 101. In some embodiments, the SCR system 150 may comprise a selective catalytic reduction filter (SCRF), or any other aftertreatment component configured to decompose constituents of the exhaust gas (e.g., NOx gases such as nitrous oxide, nitric oxide, nitrogen dioxide, etc.), flowing through the exhaust conduit 101 in the presence of a reductant, as described herein. Any suitable catalyst 154 can be used such as, for example, platinum, palladium, rhodium, cerium, iron, manganese, copper, vanadium based catalysts (including combinations thereof).

The catalyst 154 can be disposed on a suitable substrate such as, for example, a ceramic (e.g., cordierite) or metallic (e.g., kanthal) monolith core which can, for example, define a honeycomb structure. A washcoat can also be used as a carrier material for the catalyst 154. Such washcoat materials can include, for example, aluminum oxide, titanium dioxide, silicon dioxide, any other suitable washcoat material, or a combination thereof. The exhaust gas can flow over and about the catalyst 154 such that NOx gases included in the exhaust gas are further decomposed to yield an exhaust gas which is substantially free of carbon monoxide and NOx gases.

In various embodiments, the aftertreatment system 100 may also include other aftertreatment components such as, for example, an oxidation catalyst (e.g., a diesel oxidation catalyst), one or more particulate matter filters, ammonia oxidation catalysts, mixers, baffle plates, or any other suitable aftertreatment component. Such aftertreatment components may be positioned upstream or downstream of the SCR system 150 within the exhaust conduit 101.

A reductant injector 120 is mounted on the inlet tube 102 and is configured to insert reductant received from the reductant insertion assembly 130 into the exhaust gas flowing through the aftertreatment system 100. The reductant injector 120 may include one or more nozzles, valves, actuators, or any other suitable components for inserting a stream of the reductant into the exhaust gas. In some embodiments, the reductant injector 120 may be configured for air assisted delivery of the reductant into the exhaust gas.

The reductant insertion assembly 130 is fluidly coupled to the reductant storage tank 110 and is configured to provide the reductant to the reductant injector 120. The reductant insertion assembly 130 may comprise various structures to facilitate receipt of the reductant from the reductant storage tank 110 and delivery to the reductant injector 120. As shown in FIG. 1, the reductant insertion assembly 130 includes a pump 140 configured to pressurize the reductant and provide the reductant to the reductant injector 120. The pump 140 may include, for example, a diaphragm pump, a positive displacement pump, a centrifugal pump, a vacuum pump, or any other suitable configured to pressurize the reductant and deliver the reductant to the reductant injector 120 at an operating pressure and/or flow rate.

The reductant insertion assembly 130 may also include filters and/or screens (e.g., to prevent solid particles of the reductant or contaminants from flowing into the one or pumps) and/or valves (e.g., check valves) configured to draw reductant from the reductant storage tank 110. Screens, check valves, pulsation dampers, or other structures may also be positioned downstream of the one or more pumps of the reductant insertion assembly 130 and configured to remove contaminants and/or facilitate delivery of the reductant to the reductant injector 120.

In various embodiments, the reductant insertion assembly 130 may also include a bypass line structured to provide a return path of the reductant from the pump 140 to the reductant storage tank 110. A valve (e.g., an orifice valve) may be provided in the bypass line to allow selective return of the reductant to the reductant storage tank 110 (e.g., when the engine 10 is turned OFF or during a purge operation of the reductant insertion assembly 112). While FIG. 1 shows the reductant insertion assembly 130 as including a single pump 140, in other embodiments, the reductant insertion assembly 130 may include a plurality of pumps.

The pump 140 includes a housing 142 defining an internal volume 141 configured to receive the reductant from the reductant storage tank 110. A pumping element 144 (e.g., a motor, a diaphragm, an impeller, a turbine, or a piston) may be disposed within the housing 142. The pumping element 144 is configured to pressurize the reductant and communicate pressurized reductant out of the housing 142, for example, to the reductant injector 120.

In some embodiments, the housing 142 may include aluminum (e.g., may be partially or completely formed form aluminum), and the reductant may include an amount of halogen ions, for example, an amount of halogen ions greater than about 10 ppm or about 10 mg/liter. The halogen ions (e.g., chloride, bromide, fluoride or iodide ions) present in the reductant may cause the reductant to be acidic (e.g., have a pH in a range of about 2 to about 5) making it corrosive to the aluminum oxide layer that naturally forms on the aluminum surfaces of the housing 142, and that come in contact with the reductant.

To protect the housing 142 from the corrosive reductant, a corrosion resistant layer 146 is disposed on at least a portion of a surface (e.g., an inner surface) of the housing 142 that is structured to contact the reductant. The thickness of the corrosion resistant layer 146 is shown exaggerated in FIG. 1, for purposes of illustration. The corrosion resistant layer may 146 include any suitable material that resists corrosion by an acidic solution or basic solution, and particularly, resists corrosion by a reductant that includes halogen ions. In some embodiments, the corrosion resistant layer 146 comprises a fluoropolymer. The fluoropolymer may include, for example, a fluoroethylene copolymer, polytetrafluoroethylene, fluorinated ethylene propylene, perfluoroalkoxy alkane, poly(ethane-co-tetrafluoroethene), polyvinylfluoride, polyvinylidene fluoride, polychlorotrifluoroethylene, fluorinated ethylene-propylene, polyethylenechlorotrifluoroethylene, chlorotrifluoroethylenevinylidene, tetrafluoroethylene-propylene, perfluoropolyether, and/or perfluorosulfonic acid. In particular embodiments, the fluoropolymer includes polytetrafluoroethylene (e.g., TEFLON®).

The surfaces of the housing 142 that are coated with the corrosion resistant layer 146 may be prepared (e.g., abraded or polished) before disposing the corrosion resistant layer 146 thereon. In some embodiments, a thickness of the corrosion resistance layer 146 is in a range of about 40 microns to about 60 microns, inclusive. The corrosion resistance layer 146 may be configured to withstand a temperature in a range of about −40 degrees Celsius to about 80 degrees Celsius, inclusive. The corrosion resistant layer 146 may be deposited using any suitable method, for example, spray coating, dip coating, electro-spraying, electroplating, any other suitable method or a combination thereof.

In some embodiments, the pumping element 144 may also include aluminum (e.g., at least some portions of the pumping element 144 are formed from aluminum), or any other material that is susceptible to corrosion by the halogen ions present in the reductant. In such embodiments, a second corrosion resistant layer 148 is disposed on at least a portion of a surface of the pumping element 144 that is configured to contact the reductant. For example, the pumping element 144 may include an impeller, and the second corrosion resistant layer 148, which may be substantially similar to the corrosion resistant layer 146, may be disposed on surfaces of an inlet (e.g., an inlet tube), outlet and/or blades of the impeller that are configured to contact the reductant.

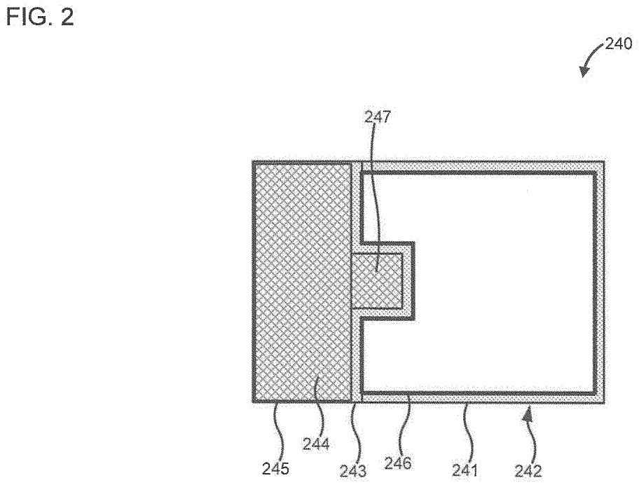

In some embodiments, only a portion of a housing and/or a pumping element of a pump may be configured to contact the reductant, and a corrosion resistant layer may be disposed on surfaces of only these portions. For example, FIG. 2 is a schematic illustration of a pump 240, according to another embodiment. The pump 240 include a housing 242 defining an internal volume. A housing first portion 241 of the housing 242 is configured to receive and/or contain the reductant and a housing second portion 243 is coupled to the housing first portion 241 such that the housing first portion 241 and the housing second portion 243 cooperatively define an enclosed volume within which the reductant may be contained. In some embodiments, a filter or screen may be disposed in the volume defined between the housing first and second portions 241 and 243 and configured filter the reductant flowing through the housing first portion 241. A pumping element 244 is disposed within a housing third portion 245 coupled to the housing second portion 243. In some embodiments, a portion 247 of the pumping element 244 (e.g., an inlet tube of the pumping element 244) protrudes into the housing first portion 241, and is also configured to contact the reductant. In other embodiments, the portion 247 may include an inlet tube extending from the housing second portion 243 into the housing first portion 241.

Each of the housing 242 and at least the portion 247 of the pumping element 244 (e.g., an inlet tube of the pumping element 244) may include aluminum, and the reductant may include a high amount of halogen ions as described herein. A corrosion resistant layer 246, which may be substantially similar to the corrosion resistant layer 146, is disposed on surfaces of the housing first portion 241, the housing second portion 243 and at least the portion 247 of the pumping element 244 that are configured to contact the reductant. The thickness of the corrosion resistant layer 246 is shown exaggerated in FIG. 2, for purposes of illustration. In some embodiments, the housing first portion 241 may include a material that is inherently corrosion resistant (e.g., is formed from plastics or a fluoropolymer). In such embodiments, the corrosion resistant layer 246 may only be disposed on surfaces of the housing second portion 243 and the portion 247 of the pumping element 244 that contact the reductant.

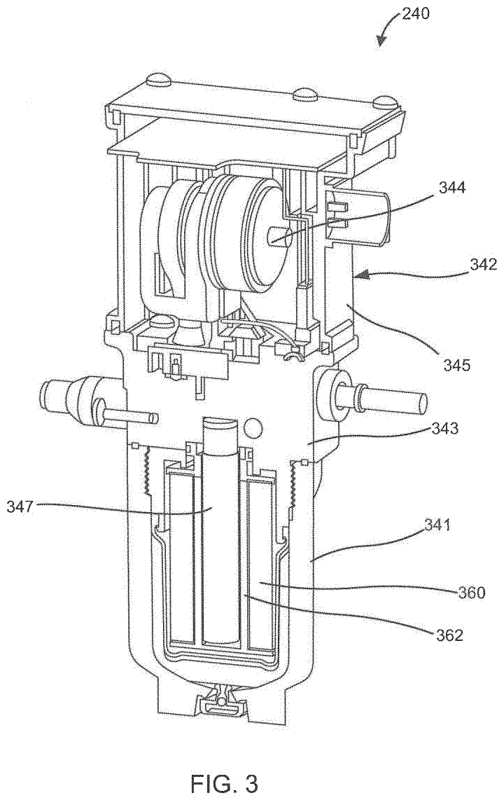

FIG. 3 is a side cross-section view of a pump 340, according to yet another embodiment. The pump 340 includes a housing 342 defining an internal volume. A housing first portion 341 of the housing 342 is configured to receive a reductant from a reductant storage tank (e.g., the reductant storage tank 110). A filter element 360 is disposed within the housing first portion and configured to filter the reductant passing through the housing first portion 341. The housing first portion 341 is formed from a material that is resistant to corrosion by a reductant having a high halogen content, as described herein.

A housing second portion 343 is coupled to the housing first portion 341, for example, serve as a cap for the housing first portion 341 so as to define an enclosed volume within which the filter 360 is disposed. The housing second portion 343 may be formed form aluminum and is therefore susceptible to corrosion by the reductant. A pumping element 344 (e.g., a motor) is disposed within a housing third portion 345 that is coupled to the housing second portion 343. An inlet tube 347 (e.g., an aluminum tube) of the pumping element 344 may protrude into the housing first portion 341 through the housing second portion 343, for example, within a central channel 362 defined through the filter 360. In other embodiments, the inlet tube 347 may be part of the housing second portion 343 and extends from the housing second portion 343 into the housing first portion 341. In such embodiments, the inlet tube 347 is fluidly coupled to an inlet of the pumping element 344. The internal surfaces of the housing second portion 343 that face the housing first portion 341 and are configured to contact the reductant, and the surfaces of the inlet tube 347 (e.g., internal and external surfaces thereof) are coated with a corrosion resistant layer that comprises a fluoropolymer (e.g., the corrosion resistant layer 146, 246).

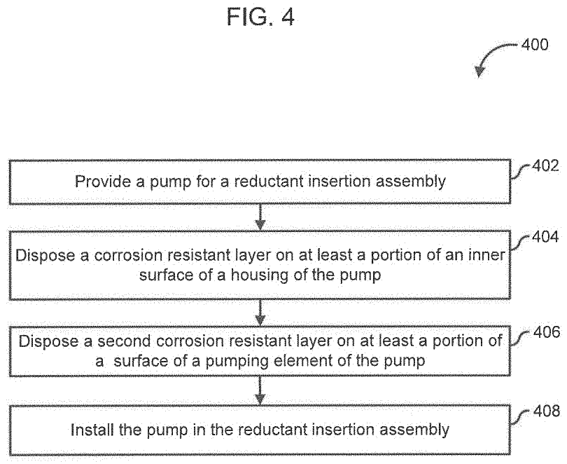

FIG. 4 is a schematic flow diagram of a method 400 for protecting a pump for a reductant insertion assembly from corrosion, according to an embodiment. While described with respect to the pump 140, 240 for use in the reductant insertion assembly 130, the method can be used for providing corrosion protection to any pump for use in any reductant insertion assembly.

The method 400 includes providing a pump for a reductant insertion assembly, at 402. For example, the pump may include the pump 140, 240 for use in the reductant insertion assembly 130. The pump may include a housing (e.g., the housing 142, 242) configured to receive a reductant, and a pumping element (e.g., the pumping element 144, 244) configured to pressurize the reductant and communicate the pressurized reductant out of the housing.

At 404, a corrosion resistant layer (e.g., the corrosion resistant layer 146, 246) is disposed on a surface (e.g., an inner surface) of the housing that is configured to house the reductant. In some embodiments, a second corrosion resistant layer (e.g., the second corrosion resistant layer 148) may also be disposed on at least a portion of a surface of the pumping element that is configured to contact the reductant, at 406.

For example, the corrosion resistant layer may be spray coated, dip coated, electroplated or disposed using any other suitable method on a surface of the housing that is configured to contact the reductant. In some embodiments, the corrosion resistant layer may be disposed on surfaces (e.g., inner surfaces) of the housing and/or at least the portion of the surface of the pumping element before the pump is assembled. At 408, the pump (e.g., the pump 140, 240) is installed in the reductant insertion assembly (e.g., the reductant insertion assembly 130).

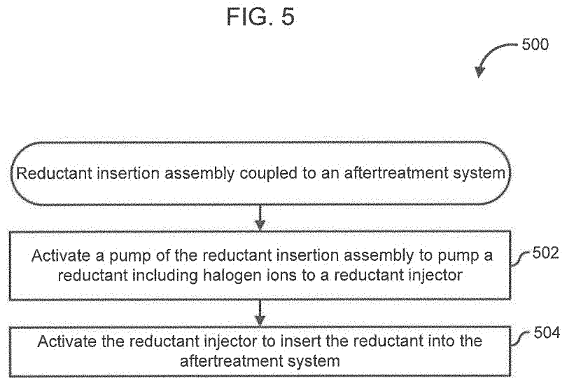

FIG. 5 is a schematic flow diagram of another method 500 for using a reductant insertion assembly (e.g., the reductant insertion assembly 130). The reductant insertion assembly is fluidly coupled to an aftertreatment system (e.g., the inlet tube 102 of the aftertreatment system 100) configured to treat constituents of an exhaust gas flowing therethrough (e.g., a diesel exhaust gas).

The method 500 includes activating a pump (e.g., the pump 140, 240, 340) of the reductant insertion assembly, at 502. The activating of the pump pressurizes a reductant that may be received from a reductant storage tank (e.g., the reductant storage tank 110) and communicates the pressurized reductant to a reductant injector (e.g., the reductant injector 120) coupled to the aftertreatment system. The pump includes a housing (e.g., the housing 142, 242, 342) configured to receive a reductant, and a pumping element (e.g., the pumping element 144, 244, 344) disposed within the housing. The pumping element is configured to pressurize the reductant and communicate the pressurized reductant out of the housing.

The housing and/or the pumping element may include aluminum and the reductant may include halogen ions (or other substances, such as road salts) that can corrode the housing and/or the pumping element. The pump further includes a corrosion resistant layer (e.g., the corrosion resistant layer 146, 246) disposed on at least a portion of a surface (e.g., an inner surface) of the housing and/or the pumping element that is configured to contact the reductant. The corrosion resistant layer includes a fluoropolymer (e.g., a fluoroethylene copolymer or polytetrafluoroethylene). At 504, the reductant injector is activated to insert the reductant into the exhaust gas flowing through the aftertreatment system.

It should be noted that the term “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

As used herein, the term “about” generally mean plus or minus 10% of the stated value. For example, about 0.5 would include 0.45 and 0.55, about 10 would include 9 to 11, about 1000 would include 900 to 1100.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Additionally, it should be understood that features from one embodiment disclosed herein may be combined with features of other embodiments disclosed herein as one of ordinary skill in the art would understand. Other substitutions, modifications, changes and omissions may also be made in the design, operating conditions and arrangement of the various exemplary embodiments without departing from the scope of the present invention.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A pump for a reductant insertion assembly, comprising:
a housing configured to receive a reductant; and
a pumping element disposed within the housing, the pumping element configured to pressurize the reductant and communicate the pressurized reductant out of the housing,
wherein the housing and/or the pumping element comprises aluminum, and
wherein the pump further comprises a corrosion resistant layer disposed on at least a portion of a surface of the housing and/or the pumping element that is configured to contact the reductant, the corrosion resistant layer comprising a fluoropolymer.

2. The pump of claim 1, wherein the fluoropolymer comprises a fluoroethylene copolymer.

3. The pump of claim 1, wherein a thickness of the corrosion resistant layer is in a range of about 40 microns to about 60 microns, inclusive.

4. The pump of claim 1, wherein the corrosion resistant layer is configured to withstand a temperature in a range of about −40 degrees Celsius to about 80 degrees Celsius, inclusive.

5. The pump of claim 1, wherein the housing comprises a housing first portion and a housing second portion coupled to the housing first portion to define an internal volume configured to receive the reductant.

6. The pump of claim 5, wherein each of the housing first portion and the housing second portion comprise aluminum, and wherein the corrosion resistant layer is coated on surfaces of each of the housing first portion and the housing second portion that are configured to contact the reductant.

7. The pump of claim 5, wherein the housing first portion comprises a corrosion resistant material and the housing second portion comprises aluminum, and wherein the corrosion resistant layer is coated only on surfaces of the housing second portion that are configured to contact the reductant.

8. The pump of claim 5, wherein a filter is disposed within the housing first portion.

9. The pump of claim 5, further comprising a housing third portion coupled to the housing second portion opposite the housing first portion,
wherein the pumping element is disposed within the housing third portion.

10. An aftertreatment system for treating constituents of an exhaust gas generated by an engine, comprising:
a selective catalytic reduction system;
a reductant storage tank configured to contain a reductant; and
a reductant insertion assembly comprising a pump as described in claim 1, the pump configured to receive reductant from the reductant storage tank and pump the reductant into the exhaust gas flowing through the aftertreatment system.

11. A method of using a reductant insertion assembly fluidly coupled to an aftertreatment system that is configured to treat constituents of an exhaust gas flowing therethrough, the method comprising:
activating a pump of the reductant insertion assembly to pressurize a reductant and communicate the pressurized reductant to a reductant injector coupled to the aftertreatment system, the pump comprising:
a housing configured to receive a reductant, and
a pumping element disposed within the housing, the pumping element configured to pressurize the reductant and communicate the pressurized reductant out of the housing,
wherein the housing and/or the pumping element comprises aluminum, and
wherein the pump further comprises a corrosion resistant layer disposed on at least a portion of a surface of the housing and/or the pumping element that is configured to contact the reductant, the corrosion resistant layer comprising a fluoropolymer; and
activating the reductant injector to insert the reductant into the exhaust gas flowing through the aftertreatment system,
wherein the reductant comprises halogen ions.

12. The method of claim 11, wherein the fluoropolymer comprises a fluoroethylene copolymer.

13. The method of claim 11, wherein a thickness of the corrosion resistant layer is in a range of about XX microns to about YY microns, inclusive.

14. The method of claim 11, wherein the corrosion resistant layer is configured to withstand a temperature in a range of about −40 degrees Celsius to about 80 degrees Celsius, inclusive.

15. The method of claim 11, wherein a concentration of halogen ions in the reductant is greater than about 10 mg/liter.

16. The method of claim 11, wherein the housing comprises a housing first portion and a housing second portion coupled to the housing first portion to define an internal volume configured to receive the reductant.

17. The method of claim 16, wherein each of the housing first portion and the housing second portion comprise aluminum, and wherein the corrosion resistant layer is coated on surfaces of each of the housing first portion and the housing second portion that are configured to contact the reductant.

18. The method of claim 16, wherein the housing first portion comprises a corrosion resistant material and the housing second portion comprises aluminum, and wherein the corrosion resistant layer is coated only on surfaces of the housing second portion that are configured to contact the reductant.

19. The method of claim 16, wherein a filter is disposed within the housing first portion.

20. The method of claim 16, further comprising a housing third portion coupled to the housing second portion opposite the housing first portion,
wherein the pumping element is disposed within the housing third portion.
